(19) United States
(12) Patent Application Publication
(10) Pub. No.: US 2003/0225586 A1
(43) Pub. Date: Dec. 4, 2003

(54) Supply chain e transformation apparatus

(76) Inventor: Jay Skibinski, Alpharetta, GA (US)

Correspondence Address: Siemens Corporation, Intellectual Property Department, 186 Wood Avenue South, Iselin, NJ, 08830, US

(21) Appl. No.: 10/160,681

(22) Filed: Jun. 3, 2002

(51) Int. Cl. G06F 17/60

(52) U.S. Cl. 705/1; 705/7

(57) ABSTRACT

Supply Chain eTransformation transforms a Target Company into an eCompany ready to integrate an eSupply Chain Management Program. The strategy component develops a strategy for transforming the Target Company into the eCompany taking into consideration success factors, business challenges and vision of the eCompany. The design component designs an eCompany model based on key performance indicators. The building component builds the eCompany model based on the design designed and the strategy and developed. The operating component rolls out the eCompany model in the Target Company to transform the Target Company into an eCompany ready to integrate with the eSupply Chain Management Program and providing a value assessment to ensure that the eCompany meets the success factors defined by the business challenges and vision of the eCompany.

### BACKGROUND

1. Field of the Invention.

The invention relates to services and solutions for offering supply chain planning and, more particularly, to a system, method & apparatus for an enhancement transaction system to transform corporate operations into an eBusiness supply chain management operation.

2. Related Information.

At the most fundamental level, a Supply Chain is a network of facilities and distribution options that performs the functions of procurement of materials, transformation of these materials into intermediate and finished products, and the distribution of these finished products to customers. Supply chains exist in both service and manufacturing organizations, although the complexity of the chain may vary greatly from industry to industry and firm to firm.

Traditionally, marketing, distribution, planning, manufacturing, and the purchasing organizations along the supply chain operated independently. These organizations have their own objectives and these are often conflicting. Marketing's objective of high customer service and maximum sales dollars conflict with manufacturing and distribution goals. Many manufacturing operations are designed to maximize throughput and lower costs with little consideration for the impact on inventory levels and distribution capabilities. Purchasing contracts are often negotiated with very little information beyond historical buying patterns. The result of these factors is that there is not a single, integrated plan for the organization—there were as many plans as businesses. Clearly, there is a need for a mechanism through which these different functions can be integrated together. Supply Chain Management is a strategy through which such an integration can be achieved.

In the early days of Supply Chain Management, there were proposed simplistic concepts that attempted to describe the Supply Chain Process in an attempt to better understand its mechanics and, therefore, develop business processes to make the process more efficient. In those times, Supply Chain Processes were classified into two broad categories—strategic and operational. Strategic decisions, which are made typically over a longer time horizon, are closely linked to the corporate strategy, and guide supply chain policies from a design perspective. Operational decisions are short term, and focus on activities over a day-to-day basis. The goal in both types of processes is to effectively and efficiently manage the product flow in the “strategically” planned supply chain. It was postulated that either strategic or operational Supply Chain Processes could be broken into four major decision areas in supply chain management: 1) location, 2) production, 3) inventory, and 4) transportation (distribution). As it turned out, these sophomoric concepts are far too simplistic to accurately describe modern day Supply Chains because they incorrectly assumed that optimization of any isolated element can be achieved.

The days of simplistic Supply Chain Management concepts with the goal of only optimizing individual isolated elements in the supply chain, or of supply chain platforms with limited interaction and collaboration capability with business partners, are definitely over. Dynamic change and globalization of markets, as well as increasing competitive pressure, brought up completely new challenges for a company's supply chain design:

To be best practice in the market companies need an information infrastructure that allows them to make accurate decisions in real time to make customer satisfaction a top priority, while still remaining competitive and profitable. Supply chains nowadays are based on “demand pull” rather than “supply push”. The fundamental challenge companies face is avoiding stock-outs and backorders without incurring excess fulfillment and inventory carrying costs. Miscalculation in forecasting that result in excess inventory can prove fatal. To handle these challenges, manufacturers are turning to new, advanced planning and scheduling techniques that generate optimized executable plans in response to rapid changes in supply or demand. In today's business environment huge amounts of data drive production planning and scheduling processes. The data comes not only from inside the organization but also from suppliers, partners and customers. Additionally, the frequency of changes in supply or demand is

increasing rapidly. Need for operational integration and collaboration of suppliers and customers leading to standardized and trusted processes, quicker and cheaper order processing and reduced costs of nonconformance.

It seems that Supply Chain Optimization today could, therefore, benefit from internet technology and its advanced optimization techniques. Supply Chain Planning solutions would seem to be fully supportable with global e-Business strategy and perfectly interact with existing transaction systems (supply chain execution). The internet promises, as an engagement into supply chain planning, to not only significantly improve competitive positioning but also securing the investment in existing supply chain execution systems.

Thus, it is no wonder that when the Internet burst onto the scene, with its promise of a ubiquitous and far less costly way to tie together companies and their operations, that the Supply Chain Management world seemed to jump headlong into the virtual world. A veritable ark of new firms, including Commerce One, i2 Technologies, NextLinx, and SeeCommerce, moved in to offer software that uses the Internet to provide constant and complete knowledge of goods as they flow from the Original Equipment Manufacturer (OEM) all the way to the Market Place. The ultimate goal is to show—in real time—the sales data, warehouse inventory, production plans, and shipment schedules of every participant in the network, and to provide tools to crunch those numbers into some form of reliable forecasting. Produce more or less? Cut or raise prices? Among the most tangible benefits of working systems today are declines in inventory of as much as 60 percent.

The history of Internet planning software begins with i2. Founded in 1988 by Sidhu, a former Texas Instruments artificial intelligence expert, i2 used a concept called the theory of constraints, which is a very scientific-sounding way of saying that there's always a smarter way to manage production. Rendered in software, it helped a company's factories communicate internally, with each other, and with headquarters to improve the flow of materials and orders. In 1995, i2 expanded its main product line, now called TradeMatrix, to work between companies, and in 1997, it branched out onto the Internet. With $1.1 billion in sales last year, i2 sold more than twice as much supply-chain software as SAP and Manugistics combined, according to AMR Research, and it is clearly a leader to follow. On the planning side, the gorilla of modern supply-chain software, Dallas-based i2, duels with Germany's SAP and Maryland-based Manugistics, while the execution group is split among a number of strong competitors.

However, there are many different parts to an Internet-enabled supply chain, and though many firms claim that their software addresses them all, the reality is that companies will likely have to go to a number of vendors to build a complete chain. Supply-chain software falls into five basic categories that cover everything from deciding what product to make to the production and design process. And there are many software applications out there that promise to solve all of the Supply Chain Problems. Each of those specialties, however, which essentially fall into two broad categories—planning and execution—are not as easily provided as the vendors would have customers believe.

There are some success stories. But, in general, the market has been driven more to sell Supply Chain Management software than to provide accurate solutions. Using i2 planning software, for example, Barnes & Noble made dramatic cuts in the inventory of its 40,000 fastest-moving titles without running short any more often than in the past. In that case, the software worked, it allowed them to better predict both the demand for the book and how quickly a publisher could replenish the stock.

On the execution side, software has been developed that allows companies to monitor the production process itself to ensure that everything happens as it should. Making sure what is planned to happen does indeed happen, which saves money by making fewer mistakes. However, there are plenty of disaster stories. Making sure that the forecasts generated by supply-chain planning software are accurate is critical as some companies found out. When a Supply Chain in the execution is off, it poses a great risk.

But the greater danger is not having enough information. One well known company was almost bankrupt for lack of information. With the software it has now, the same company estimates that planning that used to take two weeks now takes five minutes. Doing 80 percent of business on 20 percent of inventory is a possibility with software. By drastically cutting the time between the moment an order is received and when it is shipped, lag times in information are greatly reduced. Supply-chain technology, could be a gold mine of information. That is, of course, when it works.

Another problem is that, once accurate forecasts are developed, they have to be turned into reality. SeeCommerce, for example, is one company that tries to produce software that flags trouble spots by comparing supply-chain plans with actual production. The company has had success. In one instance, the software saved a company $7.5 million between July and December by analyzing data from its regional distributors to ensure that its warehouses and dealers had the right parts and inventory on hand.

But, relying on software can be hazardous. The problem with the latest supply-chain software is that it doesn't always work and often requires adjustment, which can tedious. A global show company, for example, missed quarterly earnings estimates by about one-third because of foul-ups in the supply-chain piece of a four-year, $400 million technology overhaul. The planning systems were blamed, which were run in part by i2, and i2's shares fell more than 22 percent as a result. During the next year, some analysts have predicted that 1 in 20 Internet-focused supply-chain installations will result in public relations disasters or lost profits. Software, in general, is notoriously difficult to install because it has to communicate smoothly with preexisting systems in a company as well as whatever technology tangle resides in partners' offices.

Major companies have, and often do, overlook the obvious cliche divide and conquer. Sometimes, it's important to break a project into a number of parts, install and test each section, and then move on. However, many companies erroneously put their faith blindly into software systems all at once in a bigger, longer project, which is too hard to coordinate. The problem here is that the situation often changes by the time a large undertaking is ready to be launched. For this reason, experts advise that each discrete part of the project should be done in a six- to nine-month time frame.

To get an idea of the complexity, consider the following case study. A supply-chain software project at Company A, a Silicon Valley computer peripheral maker. Company A had to employ about 20 people working on and off for a year just to set up software from Extricity that links its computers to those of its manufacturers and warehouses in Asia. Another case study of Company B, proves how difficult it is to launch a Supply Chain Management software. There, Company B used i2 software to help slash inventory, but it took about 15 people—from i2, Company B, and a Consulting firm—working full-time for six months. i2 says its average sale is just under $2 million, though those customers also tend to spend another $2 million to $3 million for consultants. And, software packages can be expensive, and high end applications, such as from i2, have been sold for as much as $100 million.

And it's not just the technology that's tough; getting staff habits and expectations in line is also a challenge. As one analyst remarked, some companies are mistakenly turning to the technology as a cure-all. A company must not fall into the false belief that just the technology will do it. The technology, left to its own devices, will throw the data around. For the data to have meaning and for people to be able to use it, analysts are now beginning to recommend that companies put a process around the data and must train people.

What is needed, therefore, is not more software focused on a Supply Chain Management Method, but, instead, a solid business plan that enables a business to restructure itself to be able to accept the eBusiness Supply Chain Management Method. What is needed is an eBusiness Supply Chain Management Transformation method that transforms the target business into an eBusiness Supply Chain Management business.

What is needed is a leaner process with higher transparency, while providing reduced cycle times and delivery times. Improved service level and higher customer satisfaction is of utmost importance and should not be lost in the process of providing automated SCM solutions. This and higher product/service availability with lower inventories is what is missing in the previous attempts. While increased productivity is a priority, so is a lower total logistic

Cost, and this is what is also lacking in the antiquated approach. Moreover, simply throwing software at SC problems does not offer better collaboration with customers and suppliers, but rather has proven to have the opposite effect.

### SUMMARY AND OBJECTS OF THE INVENTION

It is, therefore, an object of the present invention to provide leaner processes and higher transparency.

It is yet another object of the present invention to provide reduced cycle times and delivery times.

It is still another object of the present invention to provide an improved service level and higher customer satisfaction.

It is still another object of the present invention to provide a higher product/service availability with lower inventories.

It is still another object of the present invention to provide a increased productivity and lower total logistic costs.

It is still another object of the present invention to provide a better collaboration with customers and suppliers.

These and other objects are realized through the various aspects of the present invention, wherein the Supply Chain eTransformation transforms a Target Company into an eCompany ready to integrate an eSupply Chain Management Program. The strategy component develops a strategy for transforming the Target Company into the ecompany taking into consideration success factors, business challenges and vision of the ecompany. The design component designs an eCompany model based on key performance indicators. The building component builds the eCompany model based on the design designed and the strategy and developed. The operating component rolls out the eCompany model in the Target Company to transform the Target Company into an eCompany ready to integrate with the eSupply Chain Management Program and providing a value assessment to ensure that the eCompany meets the success factors defined by the business challenges and vision of the eCompany.

### BRIEF DESCRIPTION OF THE DRAWINGS

FIG. 1 is a block diagram illustrating the positioning of the Supply Chain Planning & Execution;

FIG. 2 is a block diagram illustrating the solution overview of the present invention;

FIG. 3 is a block diagram of the Supply Chain e-Transformation Process;

FIG. 4 is a block diagram of the Value Add Chain of the present invention;

FIG. 5 is a graph illustrating the experimental results of the present invention; and

FIG. 6 is a block diagram of the Business Model of the Transformation organization.

### DETAILED DESCRIPTION OF THE PREFERRED EMBODIMENTS

The present invention provides a Target Company with a Supply Chain Planning—Enhancement of Transaction System towards e-Business and an eTransformation System for transforming a Target Company to be eBusiness ready to work seamlessly with an eBusiness Supply Chain Management process.

Operating in today's increasingly dynamic environment requires a process-oriented, integrated view of the total value chain for designing, procuring, manufacturing and delivering products and services. Optimization of the Supply Chain is a crucial factor to differentiate amongst competitors.

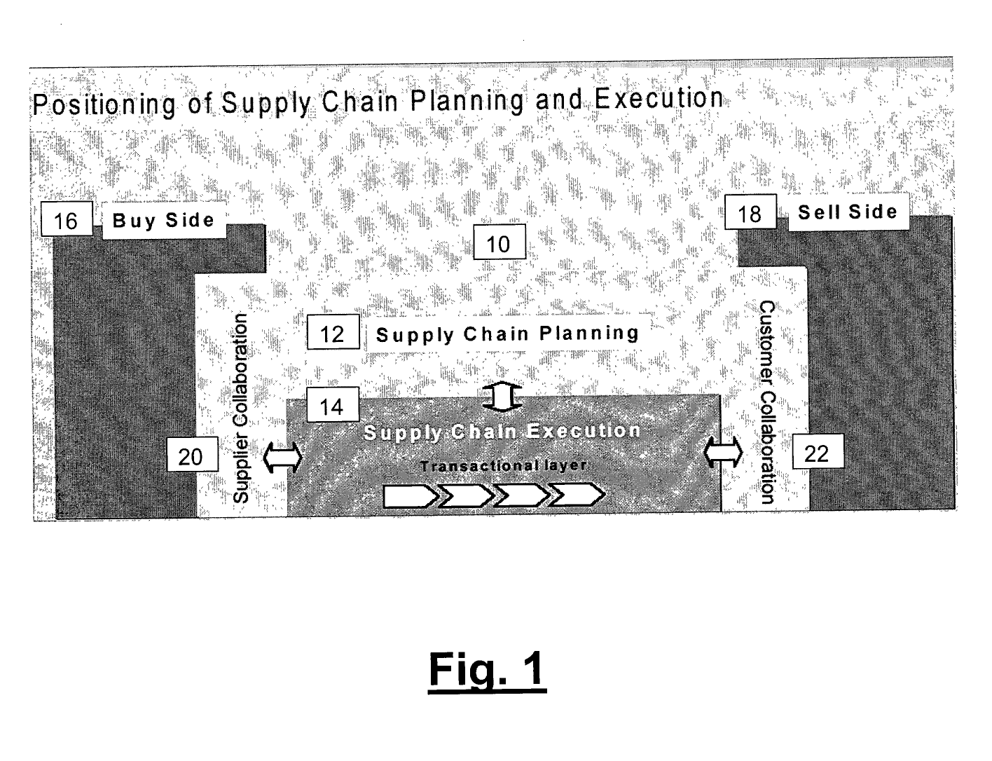

As shown in FIG. 1, Supply Chain Management (SCM) 10 is positioned at the core of an enterprise between buy-side 16 and sell-side 18 and entails integrated, process-oriented planning, control and optimization throughout the value creation chain and across all process levels—from production of the raw materials right through to delivery to the end customer.

SCM=SCE & SCP

Supply Chain Management 10 comprises 2 layers, as shown in FIG. 1, Supply Chain Execution (SCE) 12 and Supply Chain Planning (SCP) 14. Supply Chain Execution (SCE) covers the transaction and physical movement of material and products. While these kind of activities are well handled by the established transaction/ERP systems, like SAP or legacy systems, the second layer—Supply Chain Planning (SCP)—offers new opportunities to generate additional value, the SCP solutions of the present invention are designed to overlay existing transaction systems (SCE) (see FIG. 1) and pull data from every step of the supply chain from the supplier collaboration 20 on the buy-side 16 to customer collaboration 22 on the sell-side 18. The overall purpose of the present invention is to provide constraint based simulations and optimizations, as well as to set the ground for much tighter collaboration with customers and suppliers.

The purpose of the Transformation Management Operation (TMO) is to act as the control process that attains this goal. The TMO performs the following steps to achieve the transition of SCP activities as follows:

Providing consultancy for Supply Chain Management strategy.

Evaluating potential improvement areas in the supply chain.

Familiarizing the target company with the types of solutions and services already available within the TMO parent company.

Assessing their suitability for the target company.

Customizing them to fit the target companies requirements.

Providing tools and methodologies to reduce implementation costs and time.

In all these activities, the TMO acts in full compliance with the defined and published governance of the parent companies central eBusiness directives.

Business Impact

There are clear benefits of Supply Chain Planning. In contrast to traditional logistics practices, SCP solutions enable the ability to converge complex inter- and intra-enterprise operational behaviour with business strategies and information technology. Thus, the target business is allowed to focus on increasing competitive position and generating additional value for customers:

Process Integration provides faster, simpler and more transparent processes along the complete value chain, allowing for seamless interaction with customers and suppliers but also within the target enterprise. Automatic processing leads to savings in transaction costs, reduction in erroneous orders and overall faster processing, provided the customer's/supplier's back-end systems have been properly integrated. Intensive, web-based collaboration is vital in supply chain planning and execution.

Constraint Management provides the SCP with the target are able to identify all types of constraints in the target value chain and minimize them to better serve customers and save costs.

Collaborative Planning SCP plans production, transportation, sourcing and distribution to synchronize entire supply chain with customers needs and suppliers limitations. So every member of the value chain is kept informed and works proactively.

Availability & Capability Checks provides Available-to-Promise (ATP) enables to check the availabilities of components, assemblies and finished products at company and customer level, Capable-to-Promise (CTP) gives an overview about additional production and assembly capabilities.

Manufacturing Efficiency maximizes manufacturing efficiency through an increase of production throughput. With existing capacity and a decrease of the time needed to respond to constraints/problems.

End-to-End Solutions for SCP

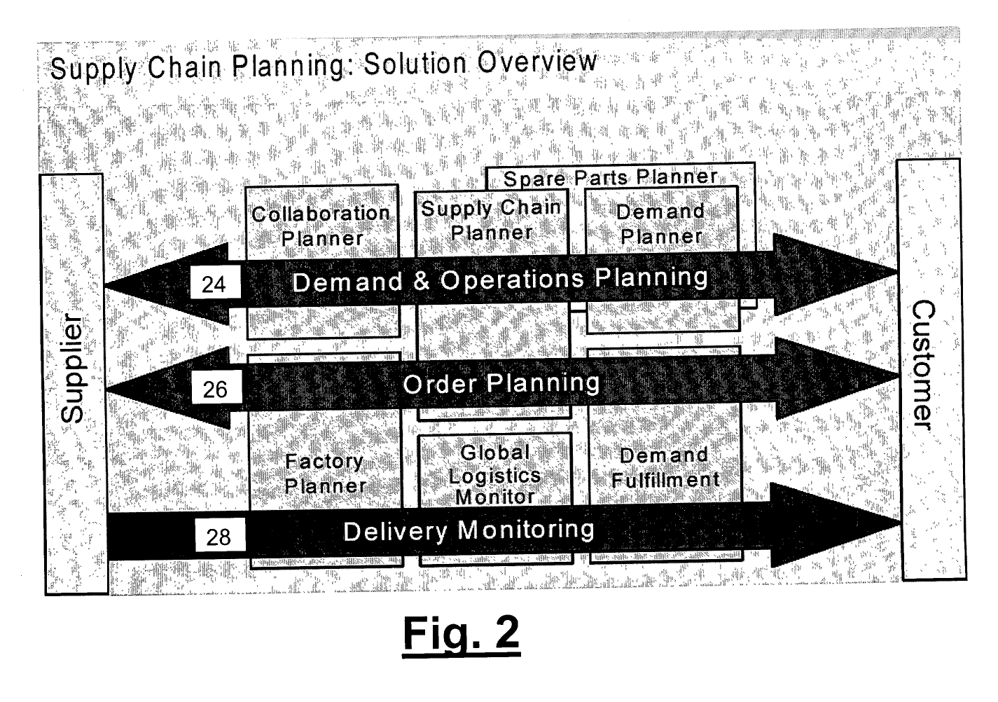

As shown in FIG. 2, Supply Chain e-Transformation executes the following three key steps which are aligned to generic key SCP processes:

Demand & Operations Planning 24 is a solution to design and implement a reliable end-to-end Collaborative Planning procedure. It calls for collecting regular forecasts from sales regions and key customers, allocating the total demands to certain production sites, and factory specific planning to providing rolling forecasts to suppliers and outsourcing partners. Central to this step, is to obtain a collaborative (agreed) and stable plan for a fixed period between all involved parent company parties. The Supply Chain Planner and the Demand

Planner, are separate sub steps, but work together to provide the aforementioned forecasts and implementation of the planning at the supply and demand stages, respectively. In the process of the invention, the Supply Chain and Demand Planners are treated as discreet operations in order to ensure that the data produced is accurate and the plan is carried out. The Spare Parts Planner, works together with the Supply Chain and Demand Planners to minimize the amount of Spare Parts by planning in advance an optimum amount of Spare Parts in relation to Supply and Demand as indicated by the Supply Chain and Demand Planning steps.

Order Planning Solution 26 is a step that provides transparent and highly effective planning and processing of customer orders. Based on different order management channels, this step reduces the reaction and delivery time (process optimization) and communicates realistic confirmation dates (ATP&CTP) to the customer. To achieve this, this step performs an optimised match between supply and demand within the entire supply chain of the target company. The Order Planning pulls data from the Supply Chain Planning sub step and compares it to data from the demand fulfillment sub step. This step initiates a Factory Planner sub step based on the optimized match sub step that performs a check of the complete process from master planning to the operational level of shop floor control to ensure that optimization is met throughout the entire factory work flow.

The Delivery Monitoring Solution 28 is step that brings the aforementioned steps and sub steps to the customer service level and ensures that the highest customer service is provided. It combines different concepts like optimized delivery (e.g. “one package to the customer”), availability of the current order status at any time, pro-active alert and event management and the right coordination between products and their appropriate services. The basic sub step is to initiate a Global Logistics Monitor that monitors customer orders throughout the entire value chain according to certain pre-defined milestones. This is achieved through a tight integration into the target ERP/transaction systems.

As will be appreciated from the above, the end-to-end solution of the present invention provides an optimal mix and alignment of streamlined processes, readjusted organizational structures with adequate change management and incentive systems and the use of the right SCP applications.

As discussed, the software by which the Supply Chain Data is obtained is not central to the invention. What is the central concept is the Business Process by which the Target Company is transformed into an eBusiness Company that is equipped to interact smoothly with the software. That said, it is recommended that the Target Company use renowned off the shelf software, such as i2 Technologies. Information regarding the use of such software is deemed not essential to patentability, but is incorporated incorporated herein by reference.

For example, “product suite” of i2 represents a comprehensive and best-in-class, end-to-end SCP architecture. The modules are designed to have certain areas of overlapping to each other. Indeed, some of the data required by the present invention might be available by already existing IT applications. So it is not always necessary to construct all of the SCP application modules. As already indicated, the final decision upon the right project scope and the right module can only be done case by case and should be carefully analyzed within the present invention. For this purpose, the present invention provides, as part of the eTransformation process, a Supply Chain e-Opportunity Assessment (SceOA). For every single application module, TMO provides the Target Company with a preconfigured solution set according to the target specific business type requirements. A solution set provides a standardized implementation

procedure and consists of prefabricated components and transformation methods. It refers to the needed roles and tasks of an implementation project. As already mentioned, the process of the present invention provides a process that, in part, implements the value added processes, by closely scrutinizing the transaction systems of the Target Company. This includes SCE as well as with the target sell side and/or buy side activities.

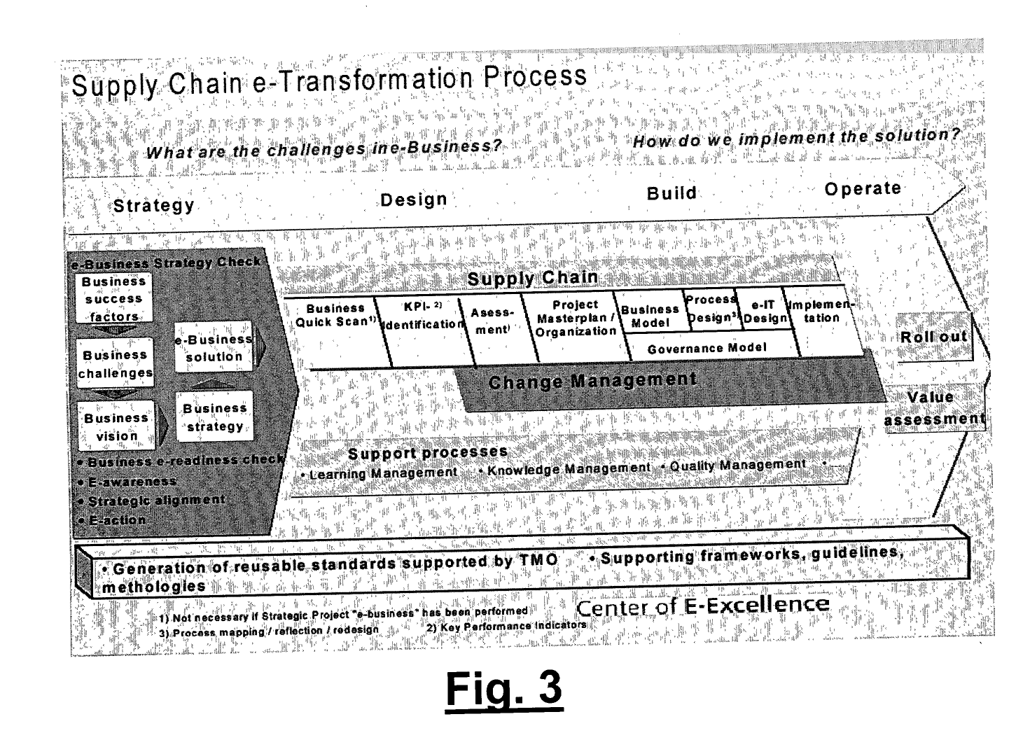

The Business Model shown in FIG. 3 provides the mechanism by which the Supply Chain e-Transformation of the Target Company is achieved. In more detail, the present invention provides that the TMO divides the task into two sets of stages. The first set of stages may be thought of as the challenges of eBusiness transformation and involves the strategy and design stages of the eTransformation. The next set of stages relates to the implementation of the solution side of the present invention including the building and operation of the transformation model. A more detailed discussion of the working model will now be discussed.

The model may be thought to begin with a strategic approach. In this initial phase, shown by the Strategy Block, the strategy encompasses the steps of initiating an e-Business Strategy Check which includes the sub steps of defining what the Business Success Factors shall be, that is, defining the goals and the measure of success of the eTransformation process. The next sub step is to define the Business Challenges that are specific to the Target Business. The challenges will differ depending upon the type of business, the market in which the business operates and the particular position the business is situated in the market. Other factors include the extent and nature of the competition and numerous other factors which are more the subject of Graduate Business School textbooks, than the present invention here. The next sub step in the process is presenting the Business Vision of the Target Business, that is, what is desired to be accomplished by the eTransformation. This is accomplished through close interaction with the Target Business. The next sub step is to develop a Business Strategy starting from the present position of the Target Business as defined by the Business Challenges sub step and the vision of where the Target Company desires to be as an eCompany, all within the framework of the measures of success defined by the Business Success Factors. An e-Business solution is mapped based on the information and data pulled from the foregoing sub steps.

The design and build phases of the Business model are focused around the Supply Chain. In the Design Phase, the invention provides a Business Quick Scan Process that provides the function of quickly scanning the Target Business as a precursor for designing an eBusiness model. However, this process may not be necessary, and may be bypassed, if the Strategic Project “eBusiness” has been performed. The next sub step in the Design Phase is to identify Key Performance Indicators (KPI). An Assessment is then made of the Target Company based on the foregoing Quick Scan and the KPI and a Project Masterplan/Organization is designed.

In the Build Phase, a Business Model Process Design is built by Mapping/Reflection/Redesign of the designed Plan. An e-Information Technologies (e-IT) Design is generated. In order to ensure that the eTransformation goes according to plan, a Governance Model for governing how the eTransformation process is carried out is set in place. Rules for Implementation of the Design are established and Change Management, regarding the effects on the Target Company and how to deal with them, is established.

In addition to the foregoing, the invention provides Support Processes, for supporting and ensuring that the smooth implementation of the eTransformation is carried out. Amongst the Support Processes is included a Learning Management process which educates the Target Company regarding the eTransformation, that is, education regarding the fundamentals of eBusiness, what the Target Company can expect from transformation, and what will be the roles and responsibilities of the personnel of the eCompany. In addition, there is provided Knowledge Management, that is, providing processes for managing how knowledge in the eTransformed Company will be shared and increased. There is also provided Quality Management, that is, maintaining that the quality level of the Supply Chain Process remains high.

In the operation part of the Business Model, the final designed and built eTransformation Model is Rolled Out, that is initiated at the Target Company. As a system of checks and balances, the invention provides a Value Assessment of the eTransformation, that oversees the transformation process and the eSupply Chain Process after Roll Out to ensure that the finished product conforms to the predefined standards for success originally provided for in the Strategic Phase of the invention.

In addition to the above, the invention also provides a framework by which there is generated reusable standards supported by TMO. That is, the invention is so designed as to be composed of discreet processes and so processes developed for the Target Company are portable and reusable for other Target Companies, or other divisions of the same Target Company.

In the underlying structure, there are, of course, the normal supporting frameworks, guidelines, and methodologies. These include the software that is needed, as previously described.

Now in more detail, the following e-Transformation Processes set forth in FIG. 3 are herein explained.

1. In order to execute the eBusiness Strategy Check, the TMO verifies the target current SCM strategy. If none exists, the TMO develops the necessary strategy together with all involved parties in the supply chain.

2. Supply Chain e-Opportunity Assessment (SceOA). Within a time span of 2-3 weeks this TMO methodology guides the Target Company to determine the financial benefits and costs of an eSupply Chain project. Based on an analysis of the target supply chain strategy, the target key processes, the target IT architecture and a best-in-class comparison, TMO identifies the most suitable supply chain roadmap for the target specific needs. The concrete deliverables, or sub steps, of this aspect of the invention from SceOA are:

Performance Gap Analysis:

Benchmarking of selected Key Performance Indicators (KPIs) is used to illustrate the performance gap of current and proposed Supply Chain Techniques.

Business Case:

Financial value and costs related to the solution are translated into the business case.

Implementation Roadmap/Plan

Based on the findings an implementation roadmap/plan including schedule and resource requirements for the eTransformation is proposed.

3. Supply Chain e-Process Design (ScePD) is a step that is highly standardized, and, therefore, prepackaged and reusable. In this step, the ScePD supplements the “classical” process re-design approach by the required e-Business aspect. Based on the “historic” Target Company version of the SCOR model (should-be-processes) and the as-is-processes, a delta analysis is performed and checked against the capabilities of the standardized IT applications.

4. SCP Testing and Prototyping. Much more persuasive than presentation slides and flyers are real SCP solutions to “look and feel”. TMO of the present invention provides pre-configured testing environments for different SCP solutions. The purpose is to provide the Target Company the possibility to check all kinds of relevant aspects like functionality, scalability, speed of processing, etc. and by this support the target decision making for certain solutions. Additionally, the TMO supplies the target with a blueprint for the target own rapid-prototyping. Here, a small pilot of the target Group, Region or Operating Company with limited business data is loaded into an e-Supply Chain solution within very limited time. This provides the Target Company with very valuable learning about content management as well as integration issues.

5. SCP Implementation and Rollout. Successful e-Supply Chain implementation goes far beyond the implementation of software and requires a complete concept combining the target strategy and the target core value added processes with technical platform issues. This becomes particularly true in the context of supply chain planning. For systems developed to support and optimize the entire value chain (end-to-end,) there is a need for robust integration with the existing transaction/SCE system, high-speed interaction with buy-side-and/or sell-side-solutions and optimal decision-making support through the use of best suitable problem solvers and algorithms.

To minimize the implementation time-frame and secure a fast learning environment for the whole project team, the implementation of SCP solutions is done in Business Releases (BR), which are clusters of project activities with defined deliverables and value achievements. TMO provides the Target Company with dedicated project coaching for the initial implementation as well as for subsequent national or international rollout projects.

6. Supply Chain e-Value Tracking (SceVT)

After the SCP implementation is done this service monitors the delivery of the proposed value. By this, the Target Company is able to control the success of the target implementation project. In case of expected or better performance, the target can focus on finding opportunities for further improvements. In case of performance worse than expected, the Target Company can show management possible reasons for shortfalls of the actual compared to the proposed situation, as well as measures to overcome these problems.

7. SCM related EAI (Sell-Side, Buy-Side, ERP)

The overall integration strategy for SCP solutions should be based on a common EAI platform integrating SCP with the primarily SAP-based ERP systems or other legacy systems, with buy-side solutions and sell-side solutions. Additionally, security issues and possible horizontal services such as product and business partner data exchange services as well as our corporate exchange services

such as OpenCS have to be considered. Whereas the ultimate goal is to integrate all solutions using the. The target company EAI tools and services, short-term solutions may require point-to-point connection or hybrid solutions. After assessment of the target implementation strategy and its corresponding translation into solutions and services, the TMO will provide the target with a blueprint of the integration issues in the target e-Supply Chain Transformation.

8. Product & Business Partner Data Exchange Service. There are a variety of formats for product catalogs even within The target company (xCBL from Cl, Etim in Electronics Retail, BMECat, or procurement in German Authorities.) Based on XML-Standards, there is a need to convert existing product data into formats that are processable by the SCP application of the present invention. To that end, a service is provided, as part of the the target company' Open Clearing Service, that provides the target with partner information about where this type of service is available.

9. Change Management is the ability to engage the middle management and to have all Supply Chain related personnel accept the changes, including such issues as change in process ownerships. In the Change Management consulting package, the invention provides the target with organizational and cultural issues, from the planning phase to their actual implementation.

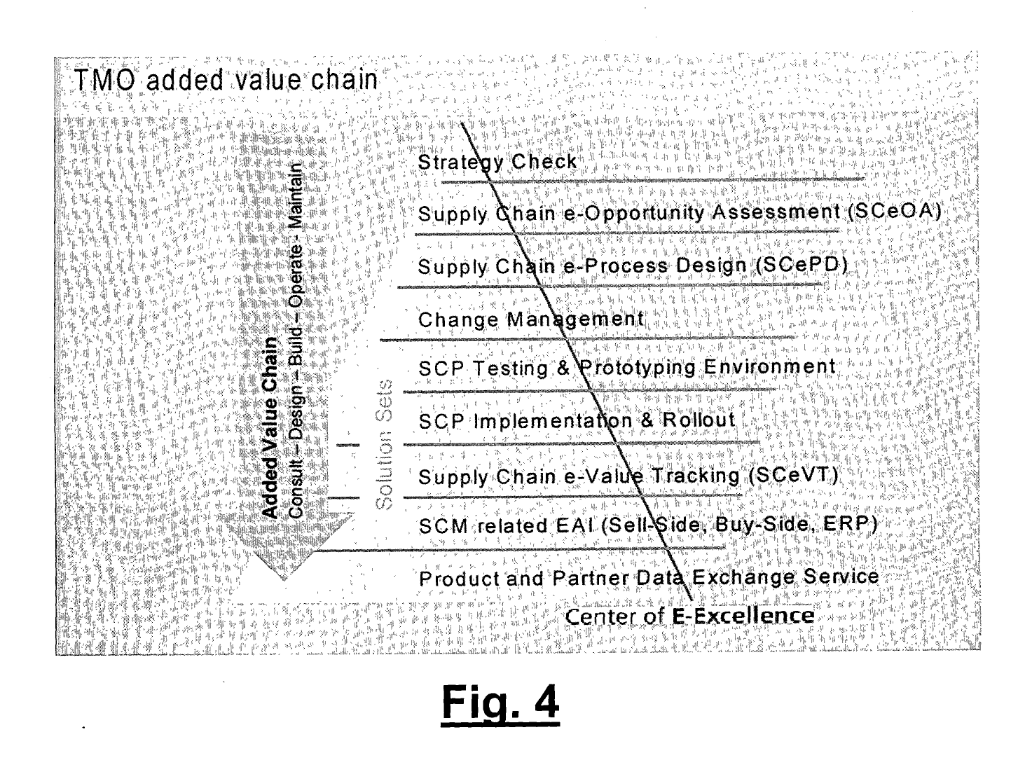

FIG. 4 illustrates the Added Value Chain provided by the TMO for the Target Business Unit. It shall be appreciated that the present invention applies a Top-Down approach to adding value to the Target Company, As shown, the Top-Down approach of the Added Value Chain from the Top Down provides Consulting, Designing, Building, Operating and Maintaining the eSupply Chain Transformation through the application of the provided Solution Sets. Namely, from the Top Down, there is provided the Strategy Check which provides the overall viewpoint from the top. The next layer down provides the Supply Chain e-Opportunity Assessment (SCeOA). Next, there is provided the next layer of Supply Chain e-Process Design (SCePD), where the SCePD design is laid out. On the next layer down we come to Change Management which provides a layer of management to the process for facilitating the implementation of the process. On the next broader layer, there is provided the SCP Testing & Prototyping Environment.

As we go further down the added value chain, we have the SCP Implementation & Rollout. It will be appreciated that the Rollout is not the final layer. Here it will be appreciated that the process does not simply end with the Rollout of the eCompany Model, but steps are taken to ensure performance criteria are met. Therefore, further on down the layer, we have the performance evaluation layers. There is, for example, the Supply Chain e-Value Tracking (SCeVT) that provides tracking. Next, there is provided the SCM related EAI (Sell-Side, Buy-Side, ERP) layer. At the base of the Top Down design, we have the Product and Partner Data Exchange Service which focuses on the completed Product and and Partner Relationships.

The TMO Services of FIG. 4 will now be described in more detail. In the context of these solution and service offers the TMO will provide the target with the following basic services:

1. Consulting Services

Starting with the E-Business Strategy Check the TMO delivers a broad range of consulting services. They range from management coaching and introductory seminars to in-depth business or process assessments, complementary change management, and corresponding implementation blueprints for the Target specific SCP project. In the consulting phase of the present invention, therefore, the target can rely on a set of standardized and proven modules of the overall e-Supply Chain project methodology (e.g. SCeOA, SCePD, SceVT) of the present invention.

2. Project Coaching and Quality Assurance

The TMO will also provide the target with dedicated project coaching that focuses on the target company eTransformation methodology, guide line templates, and lessons learned from other e-SCP projects (briefing/debriefing of project managers) as well as recommendations for the best-suited implementation partners. In this capacity, TMO provides project coaches primarily aimed at complementing and supporting the target project management to reach the desired quality.

3. Solution Sets/Corporate-Wide Application Services (CAS). The TMO provides the Target Company access to the Solution Sets, reusable components of individual transformation steps and Corporate-Wide Application Services (CAS). Thus, a new business model is delivered to provide the Target Company with the necessary standard technological support for the target transformation projects.

4. Certification Service. Here, the TMO provides a certification service to furnish implementation partners and support for their effective assignment into the target SCP projects. This also applies to the CAS services.

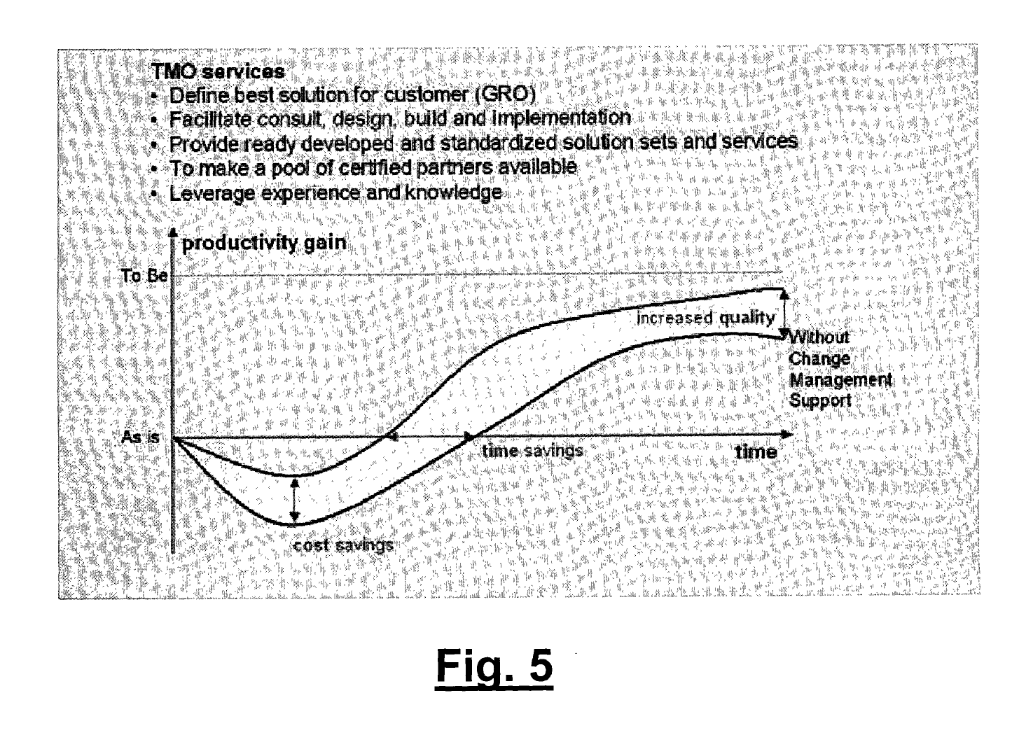

FIG. 5 illustrates the projected value by implementing the present invention. The savings in both cost and time are clearly shown in the graph. As shown, the Y-Axis represents the Productivity Gain and the X-Axis represents Time. The factors affecting the curve are shown along the Y-Axis. Both As-is and Proposed Curves are shown simultaneously to illustrate the clear advantage of using the invention.

It is estimated that using the SCM-oriented e-Transformation of the present invention will achieve an overall cost reduction of 2.5%. This is achieved with the present invention by focusing on a highly standardized set of solutions for Supply Chain Planning as innovative levers to optimize customer service levels (logistics performance), minimize throughput and lead times and reduce all supply chain related costs to a minimum (logistics costs).

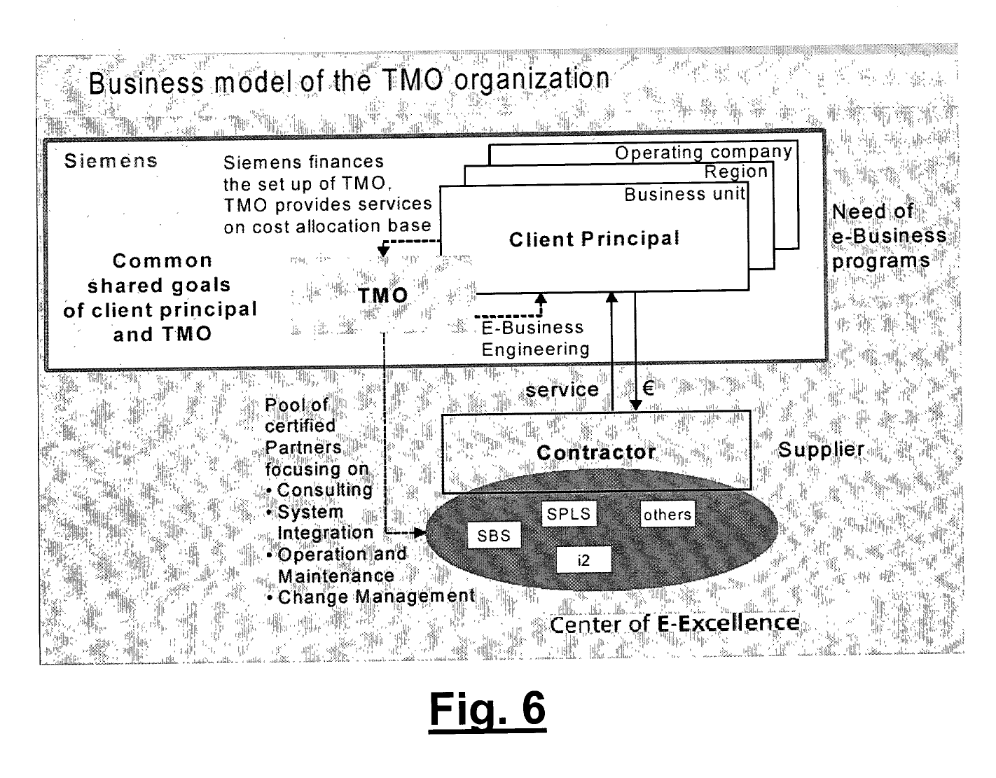

FIG. 6 illustrates the Business Model for the TMO. As previously indicated, the TMO system leads to cost and time savings and a higher degree of productivity gain. The fundamental Value Proposition of the TMO is that it is a non-profit service-oriented organization that facilitates the design, build and rollout of reusable and standardized e-business services and solutions across The target company. It shares the aims of the principal and not the contractor. The chief advantage of the TMO is that it delivers these services in close cooperation with the certified partners. Rather than acting as general contractor, the TMO Business Model of the present invention facilitate the direct contractual relationship with the Target Unit or Division and the appropriate Suppliers. This Business Model is called the “eBusiness Engineering Center”.

In one aspect of the invention, the TMO operates within a Parent Company, operating as an independent organization within the Parent to facilitate implementation of the SCP eBusiness Transformation of various Business Units of the Parent.

Thus, FIG. 6 illustrates how the TMO interacts with the Target Business and certified partners. On the most generic layer, there is a partnership of Common shared goals of the Client Principal, for example, the Parent Company, and the TMO. These common goals creates the foundation with which it is agreed that the Principal finances the operations of the TMO, which in turn provides services on a cost allocation basis. The TMO, as shown in the Figure, is in a direct contractual relationship with the Target Unit or Division, i.e., the eBusiness Engineering Center.

The Transformation Management Organization supports the implementation of all SCP solutions in accordance with pre-defined application platforms and in cooperation with certified partners, for example, within the Parent Company structure. The TMO does not, in this particular configuration, seek to supply the generic software building blocks, but rather provides the relationship between the Principal and the Contractors. As shown, the TMO does not directly finance the Contractors or purchase the software, but rather provides support in the implementation.

Between the TMO and the Contractor is provided a Pool of Certified Partners. These Partners are pre-certified by the TMO, which is part of the service provided thereby. The partners in specific areas such as for consulting services e.g. SMC, SPLS and SBS and all certified software vendors such as IBM, Interwoven, i2 and SAP, for example, could be the Pool of Partners.

The technology for the the target company Supply Chain e-transformation is, for example, based on the following partnerships:

i2 Technologies for SCP solutions

SAP as SCE or ERP system for transaction and execution

Interwoven for Content Management

Crossworlds as EAI tool

The Return on Investment (ROI) in the present invention can be best summarized in the philosophy that no “island” solution will bring the necessary benefits. The full benefits of Supply Chain e-Transformation of the present invention can best be achieved with the suitable product categories, process modifications and appropriate partners, as well as with a basic end-to-end approach to technical solutions. There is a deeper relationship between the investment volume and the resulting relative cost reduction, which once again,

underlines the necessity for a full-fledged approach, as provided by the present invention. Whereas, this normally applies to any new solution set or service, the ROI will certainly improve as the initial sets mature and become increasingly reusable.

The benefits of SCP described herein to enhancing the target bottom-line are quite apparent. Of course, the earliest possible implementation of the invention is preferred to secure maximum leverage for the target efforts from the extensive experience gained in other SCP projects. This will help the target organize the target e-transformation project with its assessment, implementation and deployment. The TMO supports the Target ensuring that the Target SCP project will deliver the added value that the Parent Board is expecting from the Target e-transformation.

In the claims:

1. A Supply Chain eTransformation apparatus for transforming a Target Company into an eCompany ready to integrate an eSupply Chain Management Program, comprising:
a strategy component that develops a strategy for transforming the Target Company into the eCompany taking into consideration success factors, business challenges and vision of the eCompany;
a design component for designing an eCompany model based on key performance indicators;
a building component for building the eCompany model based on the design designed and the strategy and developed; and
an operating component that rolls out the eCompany model in the Target Company to transform the Target Company into an eCompany ready to integrate with the eSupply Chain Management Program and providing a value assessment to ensure that the eCompany meets the success factors defined by the business challenges and vision of the eCompany.

2. The Supply Chain eTransformation apparatus of claim 1, wherein the strategy component provides an eBusiness Strategy Check where the Target Company reviews any current Supply Chain Management strategy and, if none exists, develops a strategy together with all involved parties in the supply chain.

3. The Supply Chain eTransformation apparatus of claim 1, wherein the strategy component provides a Supply Chain e-Opportunity Assessment for assessing methodologies of the Target Company.

4. The Supply Chain eTransformation apparatus of claim 3, wherein the Supply Chain e-Opportunity Assessment provides that, within a time span of 2-3 weeks of assessing the methodology, guides the Target Company to determine the financial benefits and costs of an e-Supply Chain project.

5. The Supply Chain eTransformation apparatus of claim 4, wherein, based on an analysis of the target supply chain strategy, target key processes, target IT architecture and a best-in-class comparison, the Supply Chain e-Opportunity Assessment identifies the most suitable supply chain roadmap for the target specific needs.

6. The Supply Chain eTransformation apparatus of claim 3, wherein the Supply Chain e-Opportunity Assessment provides a Performance Gap Analysis that benchmarks selected Key Performance Indicators (KPIs) to illustrate the performance gap of current and proposed Supply Chain Techniques.

7. The Supply Chain eTransformation apparatus of claim 3, wherein the Supply Chain e-Opportunity Assessment provides a Business Case Financial value and costs related to the solution are translated into the business case.

8. The Supply Chain eTransformation apparatus of claim 3, wherein the Supply Chain e-Opportunity Assessment provides an Implementation Roadmap/Plan that implements a roadmap/plan including schedule and resource requirements for the eTransformation is proposed.

9. The Supply Chain eTransformation apparatus of claim 1, wherein the design strategy component provides a Supply Chain e-Process Design (ScePD) is a step that supplements the “classical” process re-design approach by the required e-Business aspect.

10. The Supply Chain eTransformation apparatus of claim 1, wherein the design component, based on a historic Target Company version of the SCOR model compared to as-is-processes, performs a delta analysis and checked against capabilities of standardized IT applications.

11. The Supply Chain eTransformation apparatus of claim 1, wherein the design component, provides SCP Testing and Prototyping in preconfigured testing environments for different SCP solutions to check relevant aspects such as functionality, scalability and speed of processing.

12. The Supply Chain eTransformation apparatus of claim 11, wherein the Testing and Prototyping supplies the Target Company with a blueprint for the target own rapid-prototyping.

13. The Supply Chain eTransformation apparatus of claim 11, wherein the Testing and Prototyping sets up a pilot of the target Group, Region or Operating Company with limited business data is loaded into an e-Supply Chain solution within a limited time.

14. The Supply Chain eTransformation apparatus of claim 1, wherein the operating component combines concepts of target strategy and target core value added processes with technical platform issues.

15. The Supply Chain eTransformation apparatus of claim 14, wherein the operating component minimizes an implementation time-frame and secures a fast learning environment for a whole project team, by implementing SCP solutions in clusters of project activities, called Business Releases (BR), with defined deliverables and value achievements.

16. The Supply Chain eTransformation apparatus of claim 1, wherein the operating component provides the Target Company with dedicated project coaching for initial implementation as well as for subsequent national or international rollout projects.

17. The Supply Chain eTransformation apparatus of claim 1, wherein the operating component provides Supply Chain e-Value Tracking (SceVT) that monitors the delivery of the proposed value.

18. The Supply Chain eTransformation apparatus of claim 17, wherein, in order to control success of the Target Company, such that, in case of expected or better performance, the Target Company, focuses on finding opportunities for further improvements and, in case of worse than expected performance, the Target Company can determines possible reasons for shortfalls of actual compared to the eCompany Model proposed, as well as measures to overcome the worse than expected performance.

19. The Supply Chain eTransformation apparatus of claim 1, further comprising Product & Business Partner Data Exchange Service that converts XML-based standards into formats that are processable by the SCP Program.

20. The Supply Chain eTransformation apparatus of claim 1, further comprising Change Management that engages the middle management and to have all Supply Chain related personnel accept changes, including such issues as change in process ownerships including organizational and cultural issues, from planning component to their actual implementation.
